(19) United States
(12) Patent Application Publication
(10) Pub. No.: US 2026/0329993 A1
(43) Pub. Date: Oct. 22, 2026

(54) WEARABLE ELECTRONIC DEVICE AND METHOD FOR OPERATING FUNCTION ACCORDING TO USER IDENTIFICATION THEREOF

(71) Applicant: SAMSUNG ELECTRONICS CO., LTD., Suwon-si (KR)

(72) Inventors: Sangsu NAM, Suwon-si (KR); Jeongmin PARK, Suwon-si (KR); Minkyung HWANG, Suwon-si (KR)

(21) Appl. No.: 19/709,590

(22) Filed: Jun. 16, 2026

Related U.S. Application Data
(63) Continuation of application No. PCT/KR2024/020607, filed on Dec. 18, 2024.

(30) Foreign Application Priority Data
Dec. 18, 2023 (KR) 10-2023-0184914
Jan. 26, 2024 (KR) 10-2024-0012558

(51) Int. Cl. G06F 21/32; G06F 3/01; G06F 3/044

(52) U.S. Cl. CPC G06F 21/32; G06F 3/015; G06F 3/0443

(57) ABSTRACT

A wearable electronic device may include: a housing having a ring shape; a battery; a first electrode disposed inside the housing, and a second electrode disposed outside the housing; a first sensor for measuring first biometric information; a second sensor for measuring second biometric information; a second memory storing the first biometric information or the second biometric information; a processor, and a first memory storing instructions executable by the processor. The instructions, when executed by the processor, may acquire second biometric information through the second sensor based on the wearable electronic device being detected as being in a wearing state, compare the second biometric information with information stored in the second memory, identify a user wearing the wearable electronic device based on a result of the comparison, and differently configure a function executable in the wearable electronic device based on a recognition method of the identified user.

### CROSS-REFERENCE TO RELATED APPLICATIONS

This application is a continuation of International Application PCT/KR2024/020607 designating the United States, filed on Dec. 18, 2024, in the Korean Ministry of Intellectual Property Receiving Office and claiming priority to Korean Patent Application Nos. 10-2023-0184914, filed on Dec. 18, 2023, and 10-2024-0012558, filed on Jan. 26, 2024, in the Korean Ministry of Intellectual Property, the disclosures of each of which are incorporated by reference herein in their entireties.

### BACKGROUND

### Field

The disclosure relates to a wearable electronic device and a method for function operation according to user identification of the wearable electronic device.

### Description of Related Art

Wearable electronic devices including a sensor wearable on a user's body to measure biometric information and/or fitness data are being developed.

The wearable electronic device may include a glasses-type device wearable on a user's face, a watch-type device wearable on a user's wrist, or a ring-type device wearable on a user's finger.

However, ring-type wearable electronic devices are implemented without a display, as it is difficult to incorporate a display due to size limitations.

Wearable electronic devices including a sensor capable of measuring biometric information and/or fitness data when worn on a user's body are being developed.

The wearable electronic device may include a glasses-type device wearable on a user's face, a watch-type device wearable on a user's wrist, or a ring-type device wearable on a user's finger.

However, due to size limitations, ring-type wearable electronic devices are difficult to incorporate a display and are thus implemented in a structure that does not include a display.

Electronic devices without a display (e.g., ring-type wearable electronic devices) may have limitations in that they are incapable of inducing user interactions (e.g., user authentication) through the display and, therefore, the electronic devices may use functions of the electronic device in a limited manner.

### SUMMARY

Embodiments of the disclosure provide a method and device for identifying and authenticating a user in various ways by a wearable electronic device that does not include a display, and controlling operational functions differently depending on user recognition.

A wearable electronic device according to an example embodiment may include: a housing having a ring shape; a battery; a first sensor configured to measure first biometric information using an optical signal; a first electrode disposed on an inner side of the housing and a second electrode disposed on an outer side of the housing, and a second sensor configured to measure second biometric information using the first electrode and the second electrode; a first memory configured to store the first biometric information or the second biometric information; at least one processor comprising processing circuitry; a second memory configured to store instructions executable by the processor, wherein the instructions, when executed by at least one processor, individually or in any combination, may cause an the wearable electronic device to: acquire second biometric information through the second sensor, based on detecting that the wearable electronic device is in a worn state; compare the second biometric information with information stored in the first memory; identify a user wearing the wearable electronic device, based on the comparison result; and configure a function executable in the wearable electronic device differently, according to a user recognition method for the identified user.

A method of function operation according to user identification of a wearable electronic device according to an example embodiment may include: acquiring second biometric information through a second sensor in response to detecting that a ring-type wearable electronic device, including a first sensor configured to measure first biometric information using an optical signal and the second sensor configured to measure second biometric information using a first electrode and a second electrode; comparing the second biometric information with information stored in the second memory; identifying a user wearing the wearable electronic device, based on the comparison result; and configuring a function executable in the wearable electronic device differently according to a user recognition method for the identified user.

A wearable electronic device according to various example embodiments may include a non-transitory computer-readable recording medium having recorded thereon a program for implementing a method of function operation according to user identification.

A wearable electronic device, method, and recording medium according to various example embodiments may distinguish users when the wearable electronic device is worn using a biometric sensor (e.g., an ECG sensor) used for user identification and authentication, and may not only increase security by configuring operational functions differently for each user, but also support various functions/services.

The effects obtainable from the disclosure are not limited to those mentioned above, and other effects not mentioned above will become apparent to those skilled in the art to which the disclosure pertains from the following description.

### BRIEF DESCRIPTION OF THE DRAWINGS

With regard to the description of the drawings, the same or like reference numerals may be used to designate the same or like elements.

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a block diagram illustrating an example configuration of a wearable electronic device according to various example embodiments.

FIGS. 3A, 3B, 3C and 3D are diagrams illustrating example configurations of a wearable electronic device according to various example embodiments.

FIG. 4 is a diagram illustrating an example in which a wearable electronic device is worn by a user according to various example embodiments.

FIG. 5 is a flowchart illustrating an example method of function operation according to user identification of the wearable electronic device according to various example embodiments.

FIG. 6 is a flowchart illustrating an example user registration method for a wearable electronic device according to various example embodiments.

FIG. 7 is a flowchart illustrating an example method of function operation according to user identification of the wearable electronic device according to various example embodiments.

FIG. 8 is a diagram illustrating an example function control operation of a wearable electronic device based on user recognition according to various example embodiments.

FIG. 9 is a flowchart illustrating an example method of function operation according to user identification of the wearable electronic device according to various example embodiments.

### DETAILED DESCRIPTION

An electronic device according to various example embodiments disclosed may be in various forms of devices. The electronic device may include, for example, a portable communication device (e.g., a smart phone), a computer device, a portable multimedia device, a portable medical device, a camera, a wearable device, a home appliance, or the like. The electronic device according to various embodiments of the disclosure is not limited to the described devices.

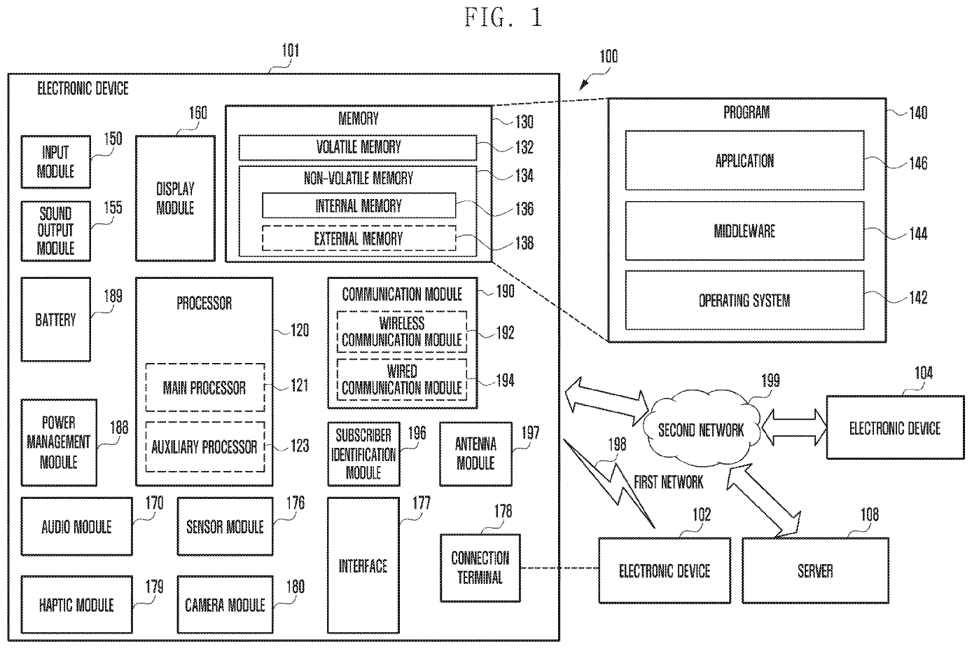

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas.

The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

An electronic device 101 according to an embodiment may interwork with a wearable electronic device 201 for sensing biometric information to provide a service related to biometric information.

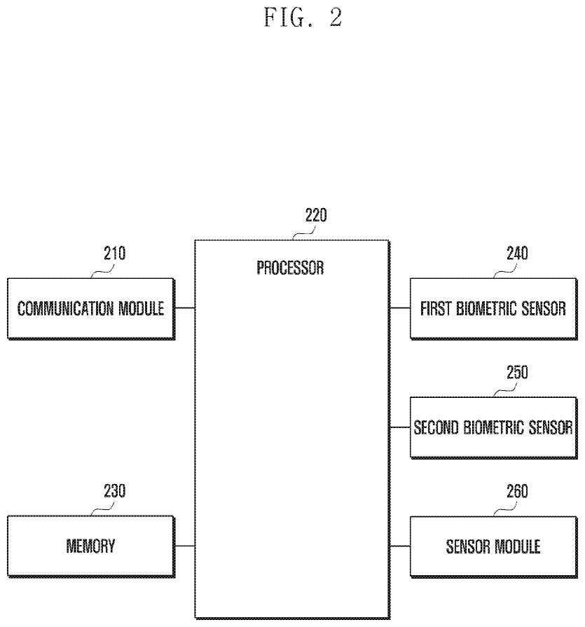

FIG. 2 is a block diagram illustrating an example configuration of a wearable electronic device according to various example embodiments.

Referring to FIG. 2, a wearable electronic device 201 according to an embodiment may be an accessory device wearable on a user's body and may be implemented to sense biometric information and transmit the same to the electronic device 101 through a communication module 210.

The wearable electronic device 201 according to an embodiment may include a communication module (e.g., including communication circuitry) 210, a processor (e.g., including processing circuitry) 220, a memory 230, a first biometric sensor 240, a second biometric sensor 250, and a sensor module (e.g., including at least one sensor) 260, but is not limited thereto. For example, the wearable electronic device 201 may further include other hardware components (e.g., an audio input/output device) illustrated in FIG. 1, in addition to the components illustrated in FIG. 2. The detailed description above with respect to the processor 120 and memory 130, apply equally to the processor 220 and memory 230 and thus a detailed description may not be repeated here.

The communication module 210 of the wearable electronic device 201 may include a communication circuit. The communication module 210 may communicate with the communication module 190 of the electronic device 101, based on a wireless communication method. The wireless communication method may include ultra-wideband (UWB) communication, which transmits and receives frequency signals in the GHz band, and Bluetooth communication, which transmits and receives radio frequency signals in the vicinity according to the Bluetooth communication standard. However, the disclosure is not limited thereto, and other communication methods capable of identifying the connection or location between the two electronic devices (e.g., the electronic device 101 and the wearable electronic device 201) may be used instead. Ultra-wideband communication may use a wide bandwidth in the GHz band to separate radio information per unit time, thereby not causing radio interference from other communication signals. For example, in ultra-wideband (UWB) communications, approximately 3.1 to 4.8 GHz may be allocated to a low band, and approximately 7.2 to 10.2 GHz may be allocated to a high band. Bluetooth communication may include not only Bluetooth communication but also Bluetooth low energy (BLE) communication.

According to an embodiment, the first biometric sensor 240 may include an optical sensor (e.g., a biometric optical sensor or a photoplethysmography (PPG) sensor) implemented to measure biometric information of a user.

For example, the first biometric sensor 240 may include a light source for emitting light, a light detector for receiving light reflected from a user's body, and a sensor IC for measuring the reflected light received by the light detector, but is not limited thereto. The first biometric sensor 240 may be used to measure and monitor biometric information of the user (or wearer) wearing the wearable electronic device 201. The first biometric sensor 240 may transmit the measured biometric information to the processor 220. The processor 220 may determine a biometric characteristic (e.g., a saturation of percutaneous oxygen (SpO2)), a heart rate (HR), a photoplethysmograph (PPG), a galvanic skin response (GSR), a bioelectrical impedance, blood sugar, hemoglobin concentration, triglycerides, body composition, an alcohol index, stress, and/or blood pressure), based on the biometric information transmitted from the first biometric sensor 240.

The second biometric sensor 250 may include at least two or more electrodes (e.g., ECG electrodes) and may include a biometric sensor that comes into contact with a living body through the electrodes to receive electrical changes of the living body.

For example, the second biometric sensor 250 may be an electrocardiogram (ECG) sensor that detects a bioelectric potential (e.g., a potential difference caused by the contraction and relaxation of heart muscles) sensed between electrodes, amplifies the detected potential, and measures (or records) an electrocardiogram. However, the second biometric sensor 250 may also be replaced by another sensor that measures a biometric signal by forming a closed-loop state using at least two or more electrodes. The ECG sensor generates a biologically meaningful ECG (electrocardiogram) signal by forming a closed-loop state by having different parts of the body (e.g., both hands) in contact with the electrodes. If a closed-loop state is not formed between the ECG sensor and the body, the signals from the electrodes may be recognized as noise or unmeasurable signals, as they have no biological significance.

The second biometric sensor 250 may be used to identify and authenticate a user (or wearer) who is wearing the wearable electronic device 201. The second biometric sensor 250 may transmit signals measured from the electrodes to the processor 220. The processor 220 may acquire an ECG signal through at least two or more electrodes (e.g., at the time a closed loop is formed), measure (or identify) a biometric feature (e.g., an ECG feature) from the ECG signal, and compare the measured biometric feature with a biometric feature (e.g., the rhythm, pattern, peak, and slope feature information of an ECG waveform) pre-stored (or registered) in the wearable electronic device 201. The processor 220 may, when the measured biometric feature matches the stored biometric feature by a predetermined criterion or more (e.g., a matching degree of 90% or more) based on comparison, identify the wearer as a previously registered user (e.g., a registered user), and complete user authentication. The processor 220 may identify the user as a different user when the measured biometric feature matches the stored biometric feature by a predetermined criterion or less based on comparison.

The sensor module 260 may include various sensors for detecting various types of information, such as motion information, environmental information, and location information of the wearable electronic device 201. The sensor module 260 may include, for example, an acceleration sensor, a gyro sensor, a proximity sensor, an ambient light sensor (or luminance sensor), an iris sensor, a temperature-humidity sensor, a touch sensor, an elevation sensor, a gesture sensor, a barometer sensor, a magnetic sensor, a grip sensor, an infrared (IR) sensor, and/or a time-of-flight (ToF) sensor, but is not limited thereto.

According to an embodiment, the first biometric sensor 240, the second biometric sensor 250, and the sensor module 260 may also be implemented in an integrated form connected to a single sensor IC.

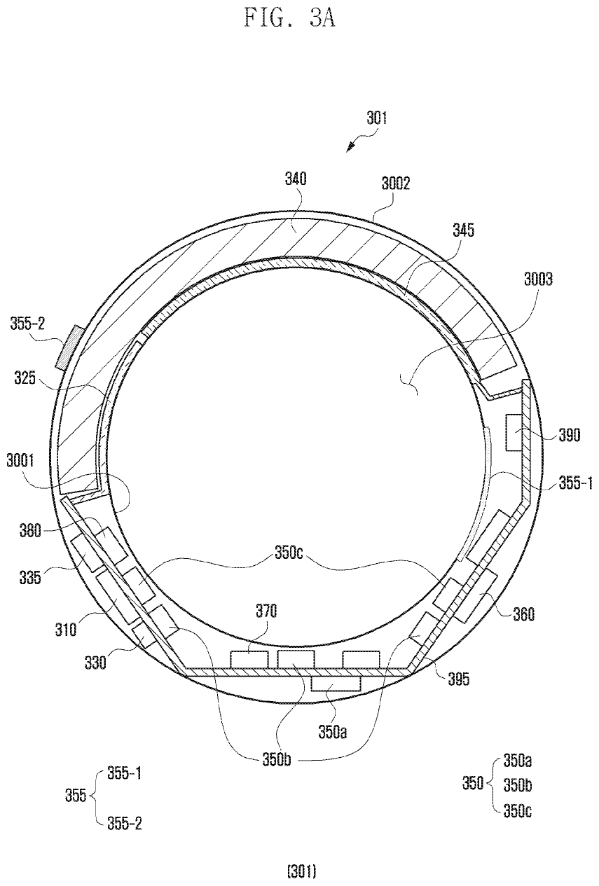

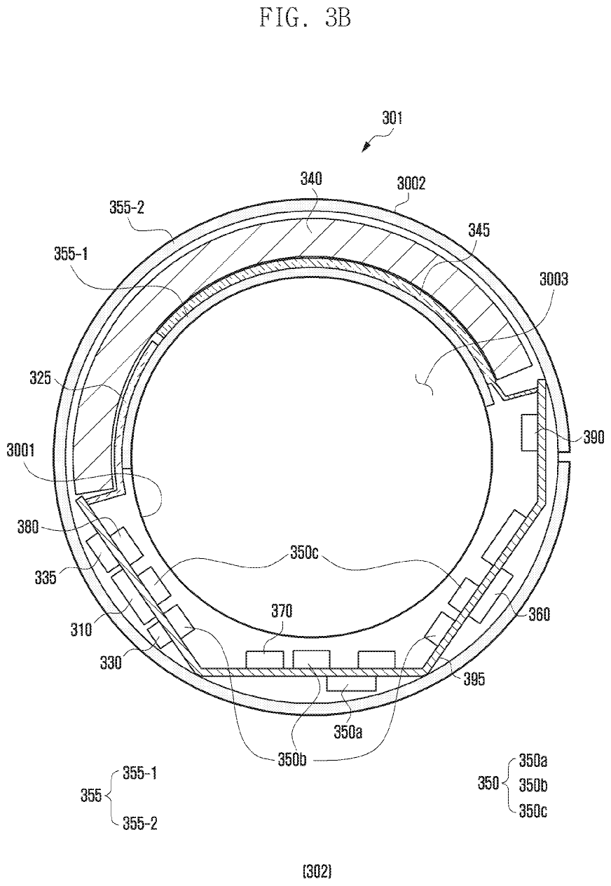

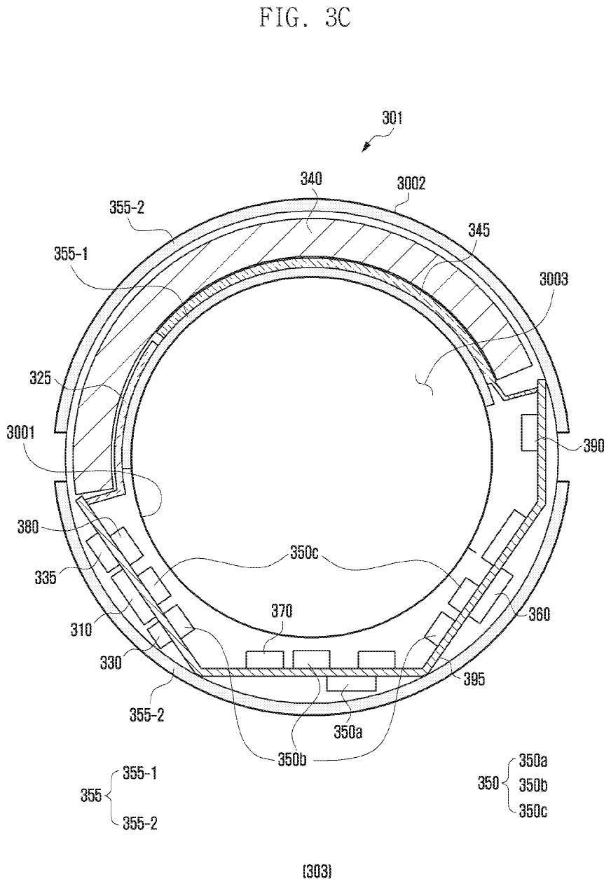

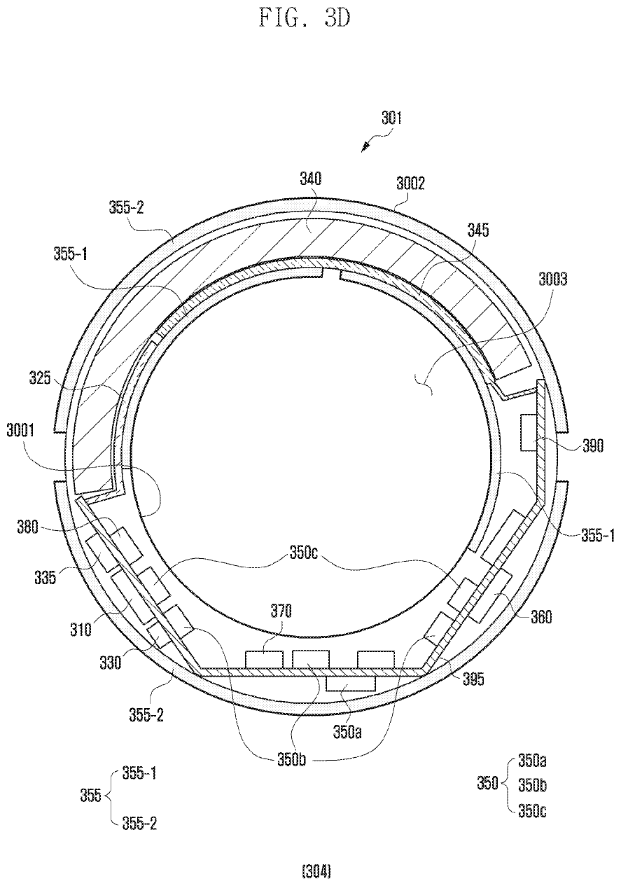

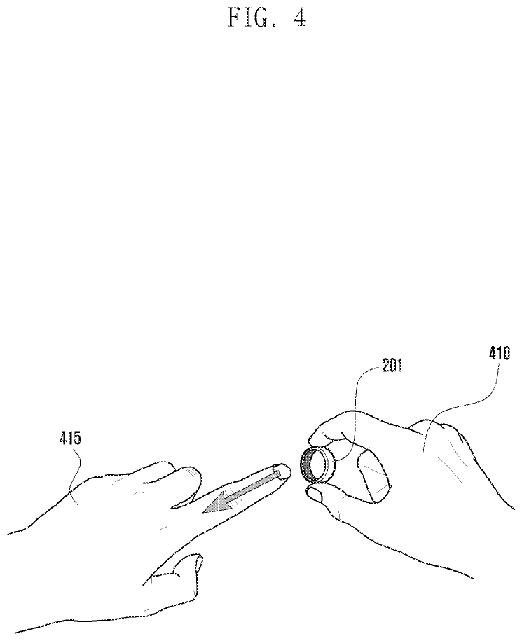

FIGS. 3A, 3B, 3C and 3D are diagrams illustrating example configurations of a wearable electronic device according to various example embodiments, and FIG. 4 is a diagram illustrating an example in which a user wears the wearable electronic device according to various example embodiments.

Referring to FIGS. 3A to 3D, in according to various example embodiments, the wearable electronic device 201 illustrated in FIG. 2 may support a biometric information sensing function, a touch function, and a wireless communication function and may refer to an electronic device of a type wearable on a user's body.

The wearable electronic device 201 may, for example, be a ring-type (e.g., a smart ring) that is worn on a finger, but may also be implemented as another type of electronic device, such as a band-type (e.g., a smart band) that does not include a display.

The wearable electronic device 201 according to an embodiment may include a first housing 3001 (e.g., an inner ring housing, a second ring housing, or a second housing portion) having a circular shape with an opening 3003, and a second housing 3002 (e.g., an outer ring housing, a first ring housing, or a first housing portion) coupled to the first housing 3001. The opening 3003 may be formed to have a size allowing a user's finger to be inserted. For example, the second housing 3002 may be formed of a material capable of withstanding external shocks or scratches, such as a metal material, ceramic, or stainless steel. A separate fixation or coating process for color implementation may also be performed on the second housing 3002. For example, the first housing 3001 may be formed of the same material as the second housing 3002, or may be formed of a molding material, plastic, or glass for sensing. At least a portion of the first housing 3001 and the second housing 3002 may include a metal material formed for biometric measurement (e.g., electrodes of a second biometric sensor 355).

The wearable electronic device 201 according to an embodiment may include a processor 310 (e.g., the processor 220 in FIG. 2), a memory 320 (e.g., the memory 230 in FIG. 2), an antenna 325, a communication module (e.g., including communication circuitry) 335, a battery 340, a charging interface (e.g., including circuitry) 345, a first biometric sensor 350 (e.g., the first biometric sensor 240 in FIG. 2), a second biometric sensor 355 (e.g., the second biometric sensor 250 in FIG. 2), a touch sensor 260 (e.g., the sensor module 260 in FIG. 2), an inertial sensor 370 (e.g., the sensor module 260 in FIG. 2), a temperature sensor 380 (e.g., the sensor module 260 in FIG. 2), and/or a power management integrated circuit (PMIC) 390, disposed in a space between the first housing 3001 and the second housing 3002. Some components may be disposed on a substrate 395 (e.g., a flexible printed circuit board (FPCB)) having flexibility to correspond to a curvature of the wearable electronic device 201.

The communication module 335 according to an embodiment may include various hardware (e.g., circuitry) and/or software configurations to support wireless communication with an electronic device (e.g., the electronic device 101 of FIG. 1). The wearable electronic device 201 may transmit and receive various data or control commands to and from the electronic device 101 via the communication module 335, either through a wired or wireless connection. In an embodiment, the communication module 335 may include the configuration of the communication module 210 in FIG. 2.

According to an embodiment, the communication module 335 may also be implemented in an integrated form with the processor 210.

The antenna 325 according to an embodiment may be connected to the communication module 335 through the substrate 395. The wearable electronic device 201 may transmit or receive a communication signal/data to or from the outside through the antenna 325. The antenna 325 may include a single antenna or multiple antennas. In various embodiments, a portion of the second housing 3002 (e.g., a metal member) may be designed to be used as the antenna 325.

The battery 340 according to an embodiment may be formed in a curved shape to have a curvature corresponding to a curvature of a space formed between the first housing 3001 and the second housing 3002. For example, the battery 340 may have a plurality of battery packs disposed separately. The battery 340 may be connected to a charging interface 345.

The charging interface 345 according to an embodiment may include various circuitry and be electrically connected to the PMIC 390 mounted on the substrate 395 through the substrate 395. For example, the charging interface 345 may support a wired charging (terminal) method or a wireless charging method (WPC, NFC) for charging.

The first biometric sensor 350 according to an embodiment may acquire various biometric information of a user using an optical signal. For example, the first biometric sensor 350 may be a photoplethysmogram (PPG) sensor or an optical sensor that measures a plethysmogram according to an optical signal to acquire various biometric information such as heart rate and blood circulation, but is not limited thereto. The first biometric sensor 350 may include a sensor controller 350a, a plurality of light emitters 350b for outputting an optical signal, and a plurality of light receivers 350c for receiving an optical signal. The light emitter 350b may include a light-emitting element that emits various wavelengths or colors (e.g., green, red) to measure a biometric signal. For example, the light emitter 350b may be formed as at least one of a light-emitting diode (LED), a semiconductor laser (laser diode (LD)), an infrared (IR) diode, and a VCSEL. For example, the light receiver 350c may be formed as a photo diode (PD) or a complementary metal-oxide-semiconductor (CMOS) camera. The light receiver 350c may convert a received optical signal through an analog-to-digital converter (ADC) and store the converted signal in the processor 310 or the memory 320. The sensor controller 350a may control the light emitter 350b and the light receiver 250c.

The second biometric sensor 355 according to an embodiment may include at least two or more electrodes 355-1 and 355-2. The second biometric sensor 355 may acquire an electrical change of a body measured from the electrodes 355-1 and 355-2, generate an ECG signal, and transmit the ECG signal to the processor 310. The electrodes 355-1 and 355-2 may be disposed so as to form a closed loop when both hands are in contact. For example, the first electrode 355-1 may be disposed in the first housing 3001 disposed to correspond to an inner side defined by a ring shape, and the second electrode 355-2 may be disposed in the second housing 3002 disposed to correspond to an outer side defined by the ring shape. The first electrode 355-1 may be referred to as an inner electrode or an inner-side electrode, and the second electrode 355-2 may be referred to as an outer electrode or an outer-side electrode.

As illustrated in FIG. 4, the second biometric sensor 355 may form a closed loop when one hand 410 is in contact with the first electrode 355-1 and the other hand 415 is in contact with the second electrode 355-2 (e.g., when the wearable electronic device 201 is held in one hand 410 and the wearable electronic device 201 is worn on a finger of the other hand 415), and thus may generate an ECG signal with a biometric feature. However, when a body is in contact with only one of the electrodes, the second biometric sensor 355 may not generate an ECG signal with a biometric feature.

When the user wears the wearable electronic device 201 as illustrated in FIG. 4, both hands are in contact at that moment, so the second biometric sensor 355 may transition to a closed-loop state and generate an ECG signal with a biometric feature.

The electrodes 355-1 and 355-2 of the second biometric sensor 355 may be implemented in various arrangement structures to form a closed loop when both hands are in contact, as illustrated in FIGS. 3A to 3D, and are not limited to the illustrated arrangement structures. For example, diagram 301 is a structure in which the first electrode 355-1 is disposed in at least a portion of the first housing 3001, and the second electrode 355-2 is disposed on at least a portion of the second housing 3002. Diagram 302 is a structure in which the first electrode 350-1 and the second electrode 355-2 are disposed so as to have greater contact areas than in diagram 301. Diagram 303 is a structure in which the first electrode 355-1 is disposed in the first housing 3001 and the second electrode 355-2 disposed in the second housing 3002 is segmented into two parts. Diagram 304 is a structure in which the first electrode 355-1 disposed in the first housing 3001 is segmented into two parts, and the second electrode 355-2 disposed in the first housing 3001 is also segmented into two parts.

The touch sensor 360 according to an embodiment may detect a touch signal of a user who touches the wearable electronic device 201. The touch sensor 360 may be formed as at least one of, for example, a pressure type, capacitive type, optical type, or ultrasonic type.

According to an embodiment, the touch sensor 360 may be omitted.

An inertial sensor 370 according to an embodiment may acquire motion information of the wearable electronic device 201. For example, the inertial sensor 370 may detect motion, gestures, impact, posture, and/or activities (e.g., sedentary, moving, sports). For example, the inertial sensor 370 may be formed as a 3-axis accelerometer, but is not limited thereto, and may also be formed as a 6-axis sensor including an accelerometer and a gyroscope.

The temperature sensor 380 according to an embodiment may measure a user's body temperature or a temperature of a component (e.g., an electronic component) included in the wearable electronic device 201. The temperature sensor 380 may be formed as a contact type or non-contact type and may vary depending on the design. For example, the wearable electronic device 201 may record temperature information obtained through the temperature sensor 380 in the memory 320, or under the control of the processor 310, measure the user's body temperature, and use the information to estimate skin temperature or context awareness.

The PMIC 390 according to an embodiment may manage the power delivered to each component of the wearable electronic device 201 from the battery 340.

The memory 320 (or the memory 230 of FIG. 2) according to an embodiment may store various instructions executable by the processor 310. Such instructions may include control commands such as arithmetic and logical operations, data transfers, or input/output processes that may be processed by the processor 310. The instructions may be stored in the memory 320 as software and may be executable by the processor 310.

The memory 330 according to an embodiment may include a first memory and a second memory.

The processor 310 (or the processor 220 in FIG. 2) according to an embodiment may be configured to perform operations or data processing for the control and/or communication of the components of the wearable electronic device 201 and may be formed as one or more processors. The operation and data processing functions that the processor 310 may implement on the wearable electronic device 201 are not limited to any specific function. In the disclosure, the processor 310 may process operations for identifying a user using the second biometric sensor 355 and for operating functions differently depending on user recognition.

According to an embodiment, as illustrated in FIG. 4, the processor 310 may measure a biometric feature from an ECG signal measured through the first electrode 355-1 and the second electrode 355-2 at the time of wearing, compare the measured biometric feature with a biometric feature stored in the memory 320, identify whether the wearer is a registered user or a different user, and complete user authentication when the wearer is a registered user.

According to an embodiment, the processor 310 may configure a function allowable in the wearable electronic device 201 differently depending on a user recognition method for the identified registered user. For example, when the user recognition method is a first method including a mobile-interworking recognition method, the processor 310 may be configured to allow a function capable of accessing security information, and when the user recognition method is a second method including a biometric feature recognition method based on an ECG signal, the processor 310 may be configured to restrict the function capable of accessing the security information.

The wearable electronic device 201 (e.g., the electronic device 101 of FIG. 1) according to an embodiment may include a housing having a ring shape. The wearable electronic device 101 according to an embodiment may include a battery. The wearable electronic device 201 according to an embodiment may include a first sensor (e.g., the first biometric sensor 240) that measures first biometric information using an optical signal. The wearable electronic device 201 according to an embodiment may include a first electrode disposed in an inner side of the housing and a second electrode disposed in an outer side of the housing, and a second sensor (e.g., the second biometric sensor 250) for measuring second biometric information using the first electrode and the second electrode. The wearable electronic device 201 according to an embodiment may include a first memory for storing the first biometric information or the second biometric information. The wearable electronic device 201 according to an embodiment may include the processor 220 or 310. The wearable electronic device 201 according to an embodiment may include a second memory for storing instructions executable by the processor. The instructions according to an embodiment may cause an operation of acquiring second biometric information through the second sensor, based on detecting that the wearable electronic device 201 is in a worn state. The instructions according to an embodiment may cause an operation of comparing the second biometric information with information stored in the first memory. The instructions according to an embodiment may cause an operation of identifying a user wearing the wearable electronic device 201, based on the comparison result. The instructions according to an embodiment may cause an operation of configuring a function executable in the wearable electronic device 201 differently according to a user recognition method for the identified user.

The instructions according to an embodiment may cause the wearable electronic device 201 to allow a first function capable of accessing security information when the user recognition method for the identified user is a first method and, restrict the first function when the user recognition method for the identified user is a second method.

A first method according to an embodiment may include a mobile-interworking recognition method that identifies and authenticates a registered user based on device identification information of an electronic device and a biometric feature based on an electrocardiogram (ECG) signal, and the second method may include an ECG recognition method that identifies and authenticates a registered user based on a biometric feature based on an ECG signal.

The first sensor according to an embodiment may include a photoplethysmography (PPG) sensor, and the second biometric sensor may include an electrocardiogram (ECG) sensor.

The instructions according to an embodiment may cause the wearable electronic device 201 to, when the user recognition method is the second method, allow a second function related to the first biometric information.

The wearable electronic device 201 according to an embodiment may further include a communication module, and the instructions may cause the wearable electronic device 201 to, based on completion of user authentication, transmit the first biometric information monitored through the first sensor to an electronic device connected to the wearable electronic device through the communication module.

The instructions according to an embodiment may cause the wearable electronic device 201 to, based on a request for execution of a third function, execute the first function when the identified user is a user authenticated by a user recognition method configured for the first function, and restrict the execution of the first function when the identified user is not a user authenticated by the user recognition method configured for the first function.

The instructions according to an embodiment may cause the wearable electronic device 201 to, when the identified user is a user authenticated by the user recognition method configured for the first function and the wearable electronic device is connected to the electronic device, execute the first function, and, when the identified user is a user authenticated by the user recognition method configured for the first function but the wearable electronic device is not connected to the electronic device, restrict the execution of the first function.

The instructions according to an embodiment may, when the second biometric information is not biometric information stored in the memory, cause the wearable electronic device 201 to guide ECG registration using an electronic device connected to the wearable electronic device.

The instructions according to an embodiment may, when the second biometric information is compared with other biometric features stored in the memory and identified as a different registered user, allow only a third function related to device control for the wearable electronic device 201 and block the first function capable of accessing security information and the second function related to biometric information.

The instructions according to an embodiment may cause the wearable electronic device 201 to, when a plurality of registered users exists, separate a storage space for storing and managing security information and biometric information for each registered user.

The instructions according to an embodiment may cause the wearable electronic device 201 to, in response to detecting that the wearable electronic device is in a dismounted state, transition the wearable electronic device to a locked state, and, based on the wearable electronic device being in a worn state, release the locked state.

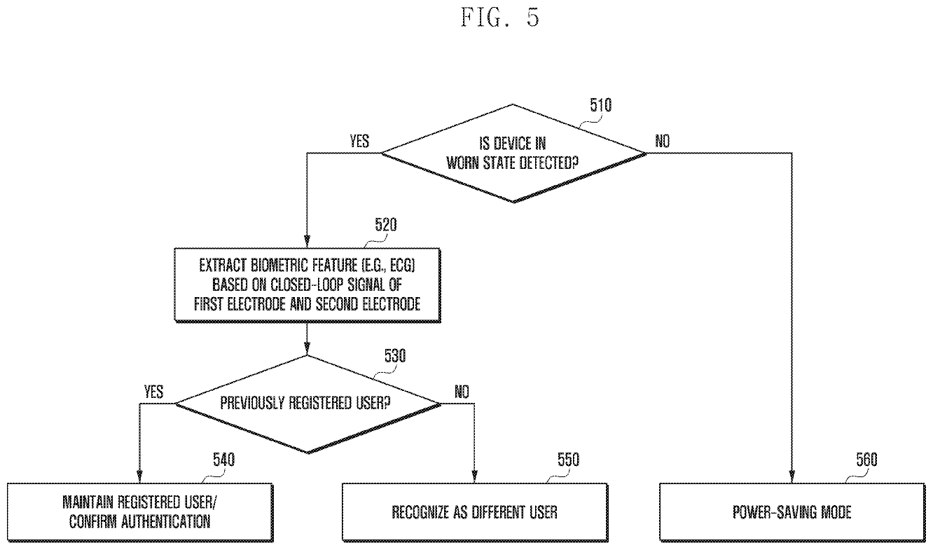

FIG. 5 is a flowchart illustrating an example operation method of a wearable electronic device based on user recognition according to various example embodiments.

Referring to FIG. 5, the processor 220 or 310 of the wearable electronic device 201 according to an embodiment may detect whether the wearable electronic device 201 is in a worn state in operation 510.

According to an embodiment, the processor 220 or 310 may detect a state of the device being mounted or dismounted, based on sensing information from sensors included in the electronic device. For example, as illustrated in FIG. 4, via a combination of sensors, the processor 220 or 310 may recognize a state in which one hand 410 is approaching the wearable electronic device 201 and is holding a part of the second housing 3002 (e.g., the second electrode 355-2) and a state in which the wearable electronic device 201 is mounted on a finger of the other hand 415 and a part of the first housing 3001 (e.g., the first electrode 355-1) is in contact with the finger.

In operation 520, the processor 220 or 310 may measure (e.g., extract) a biometric feature based on a closed-loop signal or ECG signal of the first electrode 355-1 and the second electrode 355-2.

The processor 220 or 310 may measure (or extract) a biometric feature (e.g., waveform, a feature point of the waveform, heartbeat patterns, etc.) from an ECG signal generated due to contact with both hands. For example, an ECG signal is biometric information with unique characteristics capable of distinguishing individuals and may be used as information for identifying a user.

In operation 530, the processor 220 or 310 may determine whether the user is a registered user, based on the measured biometric feature.

For example, the processor 220 or 310 may compare the biometric feature of a registered user stored (or registered) in the memory with the measured biometric feature to determine whether the user is a previously registered user.

In operation 540, the processor 220 or 310 may, as a result of the comparison, recognize (or identify) the user as a previously registered user (e.g., the registered user) when the measured biometric feature matches the stored biometric feature by a predetermined criterion or more (e.g., 90% or more matching degree) (e.g., yes in operation 530), and thus may complete user authentication.

When the user is recognized as a registered user, the processor 220 or 310 may perform configuration (e.g., a first control level) to allow access to not only security information of the wearable electronic device 201, but also all information and to enable all functions.

In operation 550, the processor 220 or 310 may recognize (or identify) the user as a different user when the comparison result indicates that the measured biometric feature matches the stored biometric feature by a predetermined criterion or less. The processor 220 or 310 may determine that the user authentication has failed, based on the recognition of the user as a different user, and may perform configuration (e.g., second control level) to block access to the security information and to restrict functions related to the security information.

When the processor 220 or 310 determines that the device is in a worn state (e.g., yes in operation 510), the processor may proceed to operation 520. When the device is in a dismounted state, which is not in a worn state (e.g., no in operation 520), the processor may proceed to operation 560 and control the device to operate in a power-saving mode (or power-saving state) or in a locked state.

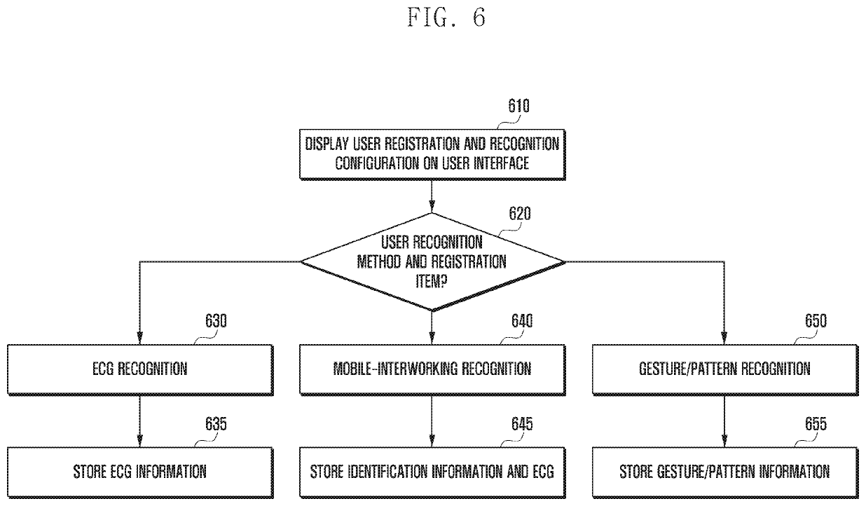

FIG. 6 is a flowchart illustrating an example user registration method for a wearable electronic device according to various example embodiments.

Referring to FIG. 6, the electronic device 101 and the wearable electronic device 201 according to an embodiment may interwork and support a function of registering a user who wears the wearable electronic device 201 through various user recognition methods (e.g., mobile-interworking recognition, ECG recognition, and gesture/pattern recognition), a function of registering multiple registered users, and a function of configuring allowable functions differently depending on a user recognition method.

The electronic device 101 may, in a state of being paired with the wearable electronic device 201, perform a series of operations to register a user wearing the wearable electronic device 201. The electronic device 101 and the wearable electronic device 201 may transmit and receive various data and/or signals through the communication module 210.

In operation 610, the electronic device 101 may display a user interface on the display to guide a user recognition method and registration configuration for a user wearing the wearable electronic device 201, and may proceed to a configuration mode. The user interface for guiding a user recognition method and registration configuration may provide instructions for user recognition method and registration processes and include items for configuring a user recognition method.

In operation 620, the electronic device 101 may determine a user recognition method and a registration item, based on the user's selection input.

In operation 630, the electronic device 101 may guide an ECG recognition method (e.g., information indicating to touch both hands on ECG electrodes) based on detecting an input for selecting the ECG recognition method.

In operation 635, the electronic device 101 may receive an ECG signal generated from ECG electrodes of the wearable electronic device 201, and store a registered user for distinguishing a user, based on a biometric feature (e.g., ECG information) included in the ECG signal. The electronic device 101 may transmit the user distinguishing information of the registered user to the wearable electronic device. For example, user #1 is stored as a user registered through ECG recognition, and user distinguishing information of user #1 (e.g., ECG recognition method #1, ECG biometric feature) may be transferred to the wearable electronic device 201.

In operation 640, the electronic device 101 may guide a mobile-interworking recognition method (e.g., registering a mobile device with the wearable electronic device and providing information guiding the user to touch both hands to ECG electrodes) based on detecting an input for selecting the mobile-interworking recognition method.

In operation 645, the electronic device 101 may store a registered user based on a biometric feature (e.g., ECG information) included in an ECG signal measured from the ECG electrodes of the wearable electronic device 201 and device identification information.

The electronic device 101 may exchange device identification information (e.g., a token) for identifying a device with the wearable electronic device 101 through a communication module. The wearable electronic device 201 may register/store the electronic device 101, based on the device identification information.

For example, user #1 is stored as a user registered through the mobile-interworking recognition method, and user distinguishing information of user #1 (e.g., mobile-interworking recognition method #1, ECG biometric feature, and device identification information #1) may be transferred to the wearable electronic device 201.

As another example, if user #2 who is different from user #1 is registered using the mobile-interworking recognition method, user distinguishing information for user #2 may include, for example, mobile-interworking recognition method #2, ECG biometric feature, and device identification information #2.

In operation 650, the electronic device 101 may guide a gesture/pattern recognition method (e.g., action information for a specific gesture using the wearable electronic device) based on detecting an input for selecting the gesture/pattern recognition method.

In operation 655, the electronic device 101 may store a registered user based on gesture/pattern information using the wearable electronic device 201. For example, the electronic device 101 and the wearable electronic device 201 may recognize a gesture utilizing the wearable electronic device 201 and may store the registered user based on the recognized gesture information. When user #3 is registered through the gesture/pattern recognition method, user distinguishing information of user #3 may include, for example, gesture/pattern recognition method #3 and gesture information.

According to an embodiment, when a user is identified as a registered user and authenticated, the user authentication for the wearable electronic device 201 may be maintained until a previously configured valid period or valid condition is maintained. For example, when a registered user is identified and user authentication is completed at the time when the wearable electronic device 201 is worn, the user authentication for the registered user may remain valid until the wearable electronic device 201 is changed to a dismounted state. For another example, while the wearable electronic device 201 is connected to the electronic device 101, user authentication for the registered user authenticated when the wearable electronic device is mounted may be valid for the wearable electronic device 201.

According to an embodiment, the wearable electronic device 201 may configure allowable functions differently for each user recognition method, as illustrated in Table 1 below.

TABLE 1

| User recognition method/Control | |
|---|---|
| method | Allowable control function group |
| Mobile-interworking recognition | First function capable of accessing |
| (e.g., first control level) | security information (e.g., pay, door |
| | lock, car key) |
| ECG recognition (e.g., second | Second function related to biometric |
| control level) | information (e.g., health data) |
| Gesture/pattern recognition | Third function related to device control |
| (e.g., third control level) | (e.g., device control) |

For example, when a user who is wearing the wearable electronic device 201 is a user identified and authenticated via mobile-interworking recognition, the wearable electronic device 201 may allow all of a first function, a second function, and a third function. When the user wearing the wearable electronic device 201 is a user identified via ECG recognition, the wearable electronic device 201 may block the first function and allow only the second and third functions. When the user wearing the wearable electronic device 201 is a user identified via gesture/pattern recognition, the wearable electronic device 201 may block the first function and the second function and allow only the third function.

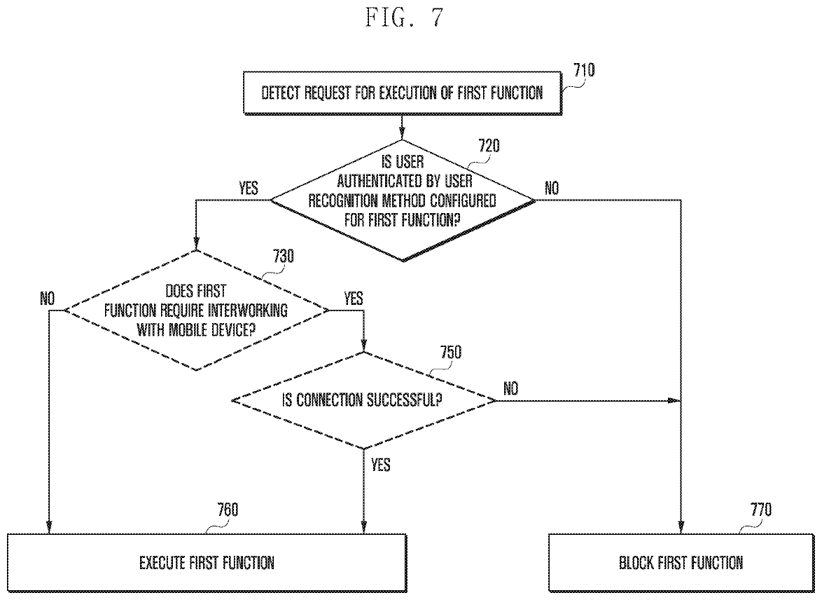

FIG. 7 is a flowchart illustrating an example operation method of a wearable electronic device based on user recognition according to various example embodiments.

Referring to FIG. 7, according to an embodiment, the wearable electronic device 201 may support a function of configuring a user recognition method differently depending on a function. For example, in the case of a door unlock function using the wearable electronic device 201, the function may be configured to be executed only when a user is authenticated via a mobile-interworking recognition method.

In operation 710, the processor 220 or 310 of the wearable electronic device 201 may detect a first function execution request.

In operation 720, the processor 220 or 310 may determine whether a user (hereinafter, a wearer) who is wearing the wearable electronic device 201 is a user authenticated via a user recognition method configured for a first function.

The processor 220 or 310 may, when the wearable electronic device 201 is in a worn state, measure a biometric feature based on an ECG signal measured through a first electrode and a second electrode, compare the measured biometric feature with biometric feature stored in a memory, and identify whether the wearer is a registered user or a different user. When the wearer is identified as a registered user, the processor 220 or 310 may complete user authentication.

For example, the first function may be configured to allow only a registered user authenticated via the mobile-interworking recognition method. The wearable electronic device 201 may identify the wearer as a registered user when the measured biometric feature is similar to a biometric feature of user #2 stored using the mobile-interworking recognition method, and may complete user authentication of user #2.

In operation 730, the processor 220 or 310 may, when the wearer is a user authenticated by the user recognition method configured for the first function (yes in operation 720), determine whether the first function requires interworking with a mobile device (or the electronic device 101).

In operation 760, when the wearer is a user authenticated by the user recognition method configured for the first function and mobile interworking is not required for the first function (no in operation 730), the processor 220 or 310 may execute the first function.

In operation 750, the processor 220 or 310 may, when the wearer is a user authenticated by the user recognition method configured for the first function and the first function requires mobile interworking (yes in operation 730), determine whether the mobile device (e.g., the electronic device 101) is in a connected state.

According to an embodiment, the operations 730 and 750 may be omitted. For example, when operation 730 is omitted, in the case where the user is authenticated by the user recognition method configured for the first function and that the user is authenticated by the mobile-interworking recognition method via mobile token exchange, mobile authentication is already completed at the time when ECG registration is performed, and thus the processor 220 or 310 may omit operations 730 and 750 and proceed to operation 760 to execute the first function.

The processor 220 or 310, when the mobile device (e.g., the electronic device 101) is in a connected state (yes in operation 750), may proceed to operation 760 and execute the first function.

The processor 220 or 310 may, when the wearer is a user authenticated by the user recognition method configured for the first function, and first function requires mobile interworking but the mobile device (e.g., the electronic device 101) is not in a connected state (no in operation 750), proceed to operation 770 to block (or restrict) the execution of the first function.

In operation 770, when the wearer is not a user authenticated via the user recognition method configured for the first function (e.g., no in operation 720), the processor 220 or 310 may block (or restrict) the execution of the first function.

The first function may be configured to allow only a registered user authenticated by the mobile-interworking recognition method. For example, when the biometric feature of the wearer does not match the biometric feature stored in the memory, the wearable electronic device 201 may identify the wearer as a different user and block (or restrict) the first function. As another example, when the biometric feature of the wearer is similar to the biometric feature of user #1 stored using an ECG recognition method, the wearable electronic device 201 may distinguish the wearer as user #1. However, since the first function only allows a registered user authenticated by the mobile-interworking recognition method, the wearable electronic device 201 may block (or restrict) the first function when the wearer is identified as user #1.

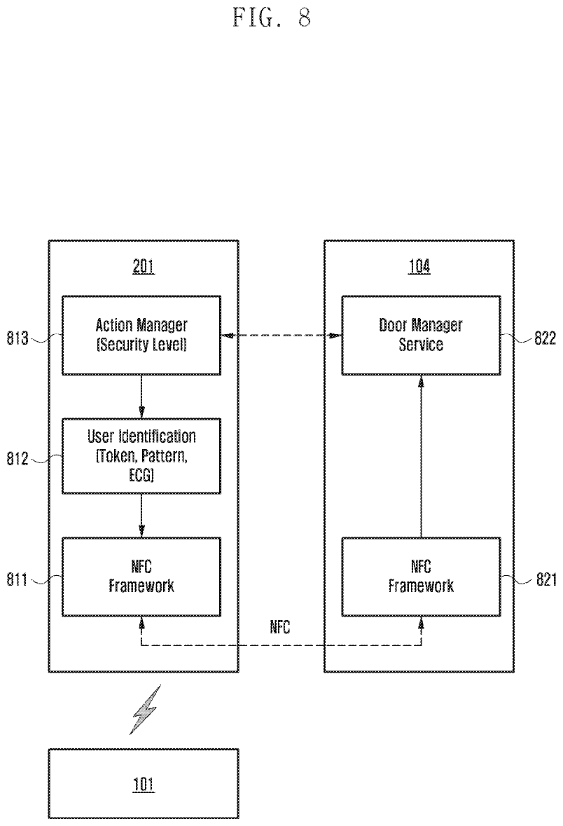

FIG. 8 is a diagram illustrating an example function control operation of a wearable electronic device based on user recognition, according to various example embodiments.

Referring to FIG. 8, the wearable electronic device 201 and the electronic device 101 according to an embodiment may support a key registration function for supporting unlocking of the door lock device 104.

For example, the door lock device 104 may register/configure a registered user who has been authenticated and the wearable electronic device 201. According to processes for user registration, a user (hereinafter, a wearer) wearing the wearable electronic device 201 while the wearable electronic device 201 is connected to the electronic device 101 may be in an authenticated state as a registered user who is registered via mobile-interworking authentication. The wearer may tag (e.g., NFC tag) the wearable electronic device 201 to the door lock device 104. The door lock device 104 may transfer key information to an NFC framework 811 of the wearable electronic device 201 through an NFC framework 821.

The wearable electronic device 201 may identify a control level related to a door lock function via an action manager 813, identify the wearer via a user identification module 812, and determine whether the identified wearer is a registered user who is allowed to use the door lock function. When the wearable electronic device 201 identifies a registered user who is permitted to use the door lock function through the user identification module 812, the wearable electronic device 201 may store the key information transferred from the door lock device 104 as security information in the memory 230 or 320. The wearable electronic device 201 may transfer a signal indicating that key information is stored and registered to the door lock device 104. The door lock device 104 may output a sound or a voice guide notifying that the wearable electronic device 201 and the authenticated user have been registered, through a door manager service 822.

The wearer may tag the wearable electronic device 210 to the door lock device for unlocking a door. The wearable electronic device 201 may determine whether the wearer is a registered user who is allowed to use the door lock function, based on a biometric feature measured based on an ECG signal generated at the time when the device is worn. When the wearer is identified as a registered user allowed to use the door lock function, the wearable electronic device 201 may transfer the stored key information to the door lock device 104 through an NFC tag, thereby unlocking the door. When the wearer is not a registered user who is allowed to use the door lock function, or is identified as a different user, even if the wearable electronic device 201 is tagged to the door lock device, the stored key information may not be transferred.

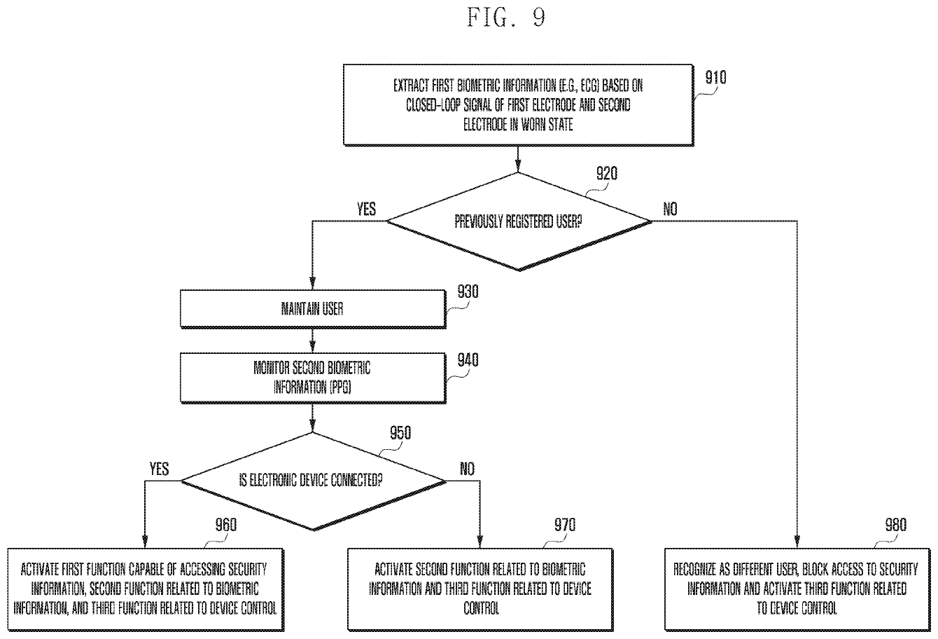

FIG. 9 is a flowchart illustrating an example function control operation of a wearable electronic device based on user recognition, according to various example embodiments.

Referring to FIG. 9, the processor 220 or 310 of the wearable electronic device 201 according to an embodiment may, in operation 910, measure (e.g., extract) a first biometric feature based on a closed-loop signal (or ECG signal) of the first electrode 355-1 and the second electrode 355-2 when the wearable electronic device 201 is worn.

In the case where a user, as illustrated in FIG. 4, grips the wearable electronic device 201 with one hand 410 and slides the wearable electronic device 201 onto a finger of the other hand 415 in order to wear the wearable electronic device 201, the wearable electronic device 201 may generate an ECG signal with a biometric feature because the electrodes 355-1 and 355-2 are in contact with the both hands at the time when the device is worn, and are transitioned to a closed loop state.

In operation 920, the processor 220 or 310 may determine whether the user (hereinafter, the wearer) who is wearing the wearable electronic device 201 is a previously registered user.

The processor 220 or 310 may measure (or extract) a biometric feature (e.g., waveform, a feature point of the waveform, heart beat patterns, etc.) from the ECG signal generated due to the contact of both hands. The processor 220 or 310 may compare the biometric feature of a registered user stored (or registered) in a memory with the measured biometric feature to determine whether the user is a previously registered user.

In operation 930, when the comparison result indicates that the wearer is a previously registered user (e.g., yes in operation 920), the processor 220 or 310 may maintain the previously registered user (hereinafter, the registered user). For example, the processor 220 or 310 may determine that the user is a previously registered user when the biometric feature measured at the time of wearing matches the stored biometric feature by a predetermined criterion or more (e.g., a matching degree of 90% or more) based on comparison.

In operation 940, the processor 220 or 310 may monitor second biometric information (e.g., a PPG signal) based on the user being maintained as a registered user. The second biometric information may be biometric information measured based on an optical biometric sensor (e.g., a first sensor).

The processor 220 or 310 may transfer the measured second biometric information to the electronic device 101 that is wirelessly connected to the wearable electronic device 201.

In operation 950, the processor 220 or 310 may determine whether the electronic device 101 is connected via wireless communication, although the user is identified as a registered user.

According to an embodiment, operation 950 may be replaced with an operation in which the processor 220 or 310 determines whether a user recognition method for the registered user is a mobile-interworking authentication method, regardless of whether the electronic device is connected.

In operation 960, the processor 220 or 310 may, when the wearer is a registered user and the electronic device is connected (or the user recognition method for the registered user is a mobile-interworking authentication method) (e.g., yes in operation 950), activate a first function capable of accessing security information, a second function related to biometric information, and a third function related to device control.

In operation 970, when the wearer is a registered user but the electronic device is not connected (or the user recognition method for the registered use is an ECG method) (e.g., no in operation 950), the processor 220 or 310 may restrict the first function and activate the second function related to biometric information and the third function related to device control.

In operation 980, when the wearer is not a registered user (e.g., no in operation 920) as a result of the comparison in operation 920, the processor 220 or 310 may recognize the wearer as a different user and may block the first function and the second function, and only activate the third function related to device control.

A method of function operation according to user identification for a wearable electronic device according to an example embodiment may include an operation of acquiring second biometric information through a second sensor in response to detecting that a ring-type wearable electronic device, which includes a first sensor for measuring first biometric information using an optical signal and the second sensor for measuring second biometric information using a first electrode and a second electrode, is in a worn state on the user's body, an operation of comparing the second biometric information with information stored in a second memory, an operation of identifying a user wearing the wearable electronic device, based on the comparison result, and an operation of configuring a function executable in the wearable electronic device differently according to a recognition method for the identified user.

The operation of differently configuring a function executable by the wearable electronic device according to an embodiment may allow a first function capable of accessing security information when the user recognition method for the identified user is a first method, and restrict the first function when the user recognition method for the identified user is a second method.

According to an example embodiment, the first method may include a mobile-interworking recognition method for identifying and authenticating a registered user, based on device identification information of the electronic device and a biometric feature based on an ECG signal, and the second method may include an ECG recognition method for identifying and authenticating a registered user, based on a biometric feature based on an ECG signal.

The operation of differently configuring a function executable by the wearable electronic device according to an embodiment may further include, when the user recognition method is the second method, an operation of allowing a second function related to the first biometric information.

The method may further include, based on a request for executing a third function according to an embodiment, an operation of executing the first function when the identified user is a user authenticated by a user recognition method configured for the first function, and restricting the execution of the first function when the identified user is not a user authenticated by the user recognition method configured for the first function.

The operation of acquiring the second biometric information according to an embodiment may include, based on the wearable electronic device being transitioned from a dismounted state to a mounted state, an operation of changing a lock state of the wearable electronic device to an unlocked state to acquire the second biometric signal.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A wearable electronic device comprising:
a housing having a ring shape;
a battery;
a first electrode disposed on an inner side of the housing and a second electrode disposed on an outer side of the housing;
a first sensor configured to measure first biometric information using an optical signal;
a second sensor configured to measure second biometric information using the first electrode and the second electrode;
at least one processor comprising processing circuitry; and
a memory configured to store instructions executable by at least one processor,
wherein the instructions, when executed by at least one processor, individually or in any combination, cause the wearable electronic device to:
based on detecting that a first object comes into contact with the first electrode and a second object comes into contact with the second electrode, acquire second biometric information corresponding to a closed-loop signal via the second sensor, and
compare the second biometric information with user information stored in the memory to identify whether a user wearing the wearable electronic device is a previously registered user, and
based on identifying the user as the previously registered user, allow a first function capable of access to security information based on a user recognition method for the previously registered user being a first method; and
restrict the first function based on the user recognition method for the previously registered user being a second method.

2. The wearable electronic device of claim 1, wherein the first method includes a mobile-interworking recognition method in which a registered user is identified and authenticated using device identification information of an electronic device and a biometric feature based on an electrocardiogram (ECG) signal, and the second method includes an ECG recognition method in which a registered user is identified and authenticated using a biometric feature based on an ECG signal.

3. The wearable electronic device of claim 1, wherein the first sensor includes a photoplethysmography (PPG) sensor and the second biometric sensor includes an electrocardiogram (ECG) sensor.

4. The wearable electronic device of claim 1, wherein the instructions, when executed by at least one processor, individually or in any combination, cause the wearable electronic device to allow a second function related to the first biometric information collected via the first sensor based on the user recognition method being the second method.

5. The wearable electronic device of claim 1, further comprising a communication module, comprising communication circuitry,
wherein the instructions, when executed by at least one processor, individually or in any combination, cause the wearable electronic device to, based on completion of user authentication, transmit, via the communication module, the first biometric information monitored via the first sensor to an electronic device connected to the wearable electronic device.

6. The wearable electronic device of claim 1, wherein the instructions, when executed by at least one processor, individually or in any combination, cause the wearable electronic device to:
receive an input requesting execution of a third function;
based on the input requesting the execution of the third function, execute the first function based on the previously registered user being a user authenticated by a user recognition method configured for the first function; and
based on the input requesting the execution of the third function, restrict execution of the first function based on the previously registered user not being a user authenticated by the user recognition method configured for the first function.

7. The wearable electronic device of claim 5, wherein the instructions, when executed by at least one processor, individually or in any combination, cause the wearable electronic device to:
execute the first function based on the previously registered user being a user authenticated by a user recognition method configured for the first function and the wearable electronic device being connected to the electronic device; and
restrict execution of the first function based on the previously registered user being a user authenticated by the user recognition method configured for the first function but the wearable device not being connected to the electronic device.

8. The wearable electronic device of claim 1, wherein the instructions, when executed by at least one processor, individually or in any combination, cause the wearable electronic device to:
based on the second biometric information not being user information stored in the memory, guide ECG registration using an electronic device connected to the wearable electronic device.

9. The wearable electronic device of claim 1, wherein the instructions, when executed by at least one processor, individually or in any combination, cause the wearable electronic device to:
based on the user being identified as a different registered user as a result of comparing the second biometric information with the user information stored in the memory, block the first function capable of access to security information and the second function related to biometric information, and allow only a third function related to device control.

10. The wearable electronic device of claim 9, wherein the instructions, when executed by at least one processor, individually or in any combination, cause the wearable electronic device to separate a storage space for storing and managing security information and biometric information for each registered user in the memory based on there being a plurality of registered users.

11. The wearable electronic device of claim 9, wherein the instructions, when executed by at least one processor, individually or in any combination, cause the wearable electronic device to switch the wearable electronic device to a locked state, in response to detecting that the wearable electronic device is in a detached state, and release the locked state, based on the wearable electronic device being in a worn state.

12. A method for operating a function according to user identification of a wearable electronic device, the method comprising:
in response to detecting that a first object comes into contact with a first electrode and a second object corners into contact with a second electrode of a ring-type wearable electronic device comprising a first sensor configured to measure first biometric information using an optical signal and a second sensor configured to measure second biometric information using the first electrode and the second electrode, acquiring the second biometric information corresponding to a closed-loop signal via the second sensor;
comparing the second biometric information with user information stored in the second memory to identify whether a user wearing the wearable electronic device is a previously registered user; and
based on identifying the user as the previously registered user, allowing a first function capable of access to security information based on a user recognition method for the previously registered user being a first method, and restricting the first function based on the recognition method for the previously registered user being a second method.

13. The method of claim 12, wherein the first method includes a mobile-interworking recognition method in which a registered user is identified and authenticated using device identification information of an electronic device and a biometric feature based on an ECG signal, and the second method includes an ECG recognition method in which a registered user is identified and authenticated using a biometric feature based on an ECG signal.

14. The method of claim 12, further comprising allowing a second function related to the first biometric information based on the user recognition method for the previously registered user being the second method.

15. The method of claim 12, further comprising:
receiving an input requesting execution of a third function;
based on the input requesting the execution of the third function, executing the first function based on the previously registered user being a user authenticated by a user recognition method configured for the first function; and
based on the input requesting the execution of the third function, restricting execution of the first function based on the previously registered user not being a user authenticated by the user recognition method configured for the first function.
